(19) United States
(12) Patent Application Publication
(10) Pub. No.: US 2004/0010516 A1
(43) Pub. Date: Jan. 15, 2004

(54) System and method for assigning globally unique identifiers to attractions based upon their geographical locations and/or categories

(76) Inventor: Yu Meng, Bronx, NY (US)

Correspondence Address: Yu Meng, Apt 3D, 3512 Oxford Ave, Bronx, NY, 10463, US

(21) Appl. No.: 10/452,529

(22) Filed: Jun. 2, 2003

Related U.S. Application Data
(60) Provisional application No. 60/395,462, filed on Jul. 15, 2002.

(51) Int. Cl. G06F 7/00

(52) U.S. Cl. 707/104.1

(57) ABSTRACT

The system and method of the invention assign globally unique identifiers to attractions. An attraction is a natural or manmade object or site that is of actual or potential historical, emotional, or aesthetic significance. The identifier contains information about the geographical location and/or category of the attraction. When the information about the attraction is stored, the unique identifier can be used as a bookmark to retrieve relevant information.

### BACKGROUND OF THE INVENTION

This invention relates to a system and method of assigning globally unique identifiers that identify attractions based upon their geographical locations and/or categories.

An attraction is a natural or manmade object or site that is of actual or potential historical, emotional, or aesthetic significance. Attractions are under the purview of public or private caretakers in different countries based on the geographical locations of the attractions. Because of the globalization of economic activities, geographical distance presents fewer barriers than it has in the past. As one result, people need access to dynamic information about attractions around the world. To make that possible, it is necessary to have a way to access specific information about an attraction quickly and easily. This requires a way to identify attractions in different locations.

One example of an identification system is that used by the Federal Aviation Administration (FAA). All general aviation aircraft in the United States are registered by the FAA with a unique N number. An N number uniquely identifies each aircraft and is used by the pilot when communicating with air traffic controllers.

Just as with N numbers, the present invention assigns a globally unique attraction identifier (GUAID) to each attraction. The unique identifiers in the present invention are analogous to the N numbers. GUAIDs are the N numbers for attractions.

The World Heritage Committee assigns numbers to selected cultural and natural properties. Each number is only a sequential number which does not reveal any information about the geographical location and category of the property. And the number is used only by the Committee internally and cannot be used as a unique identifier by others. Attractions as used in the current invention encompass far more than cultural and natural properties.

Using the unique identifiers in the current invention offers many advantages. When information about a particular attraction is stored, the unique identifier for that attraction provides a convenient means to retrieve relevant information quickly and easily.

No prior system currently exists in which unique identifiers have been assigned to attractions as in the present invention.

### BRIEF SUMMARY OF THE INVENTION

It is an object of the invention to assign globally unique attraction identifiers (GUAIDs) for attractions based upon their geographical locations and/or categories.

It is another object of the invention to retrieve relevant information about an attraction by means of its GUAID when the information is stored. The GUAID can be used as a bookmark. Therefore, relevant information can be retrieved easily and effectively with the correspondent GUAID.

Briefly, the present invention relates to a system and method for storing information about attractions in a database.

When the system receives information about a supposedly unregistered attraction, it compares newly inputted information with information stored in the database to determine its registration status. If the system verifies that it is unregistered, it assigns a GUAID for that attraction.

The administrator of the system may modify the generated GUAID. The GUAID and the inputted attraction information will be saved in the database for further uses.

In general, the present invention provides a system and method of assigning globally unique identifiers that identify attractions based upon their geographical locations and/or categories. When the information about the attraction is stored, the unique identifier can be used as a bookmark to retrieve relevant information.

The above and other objects and advantages of the invention will become more readily apparent when reference is made to the description in conjunction with the accompanying drawings.

### BRIEF DESCRIPTION OF THE DRAWINGS

FIG. 1 is an overall block diagram of the GUAID management system typical of the present invention.

FIG. 2 is a flow chart illustrating the operations of the GUAID Management Module shown in FIG. 1.

FIG. 3 is a typical display screen that shows the GUAID assignment interface.

### DETAILED DESCRIPTION OF THE INVENTION

Glossary of Terminology

Attraction

Natural or manmade object or site that is of actual or potential historical, emotional, or aesthetic significance

Attraction Data

Data pertaining to each attraction, including name, address, and description

Attraction Information

Information for a specific attraction, including location data, category data, attraction data, and GUAID

Globally Unique Attraction Identifier

A globally unique string that identifies an attraction based upon its geographical location and/or category

GUAID

An abbreviation for “Globally Unique Attraction Identifier”

GUAID Management System

The computer system constructed for the present invention that manages GUAIDs for attractions

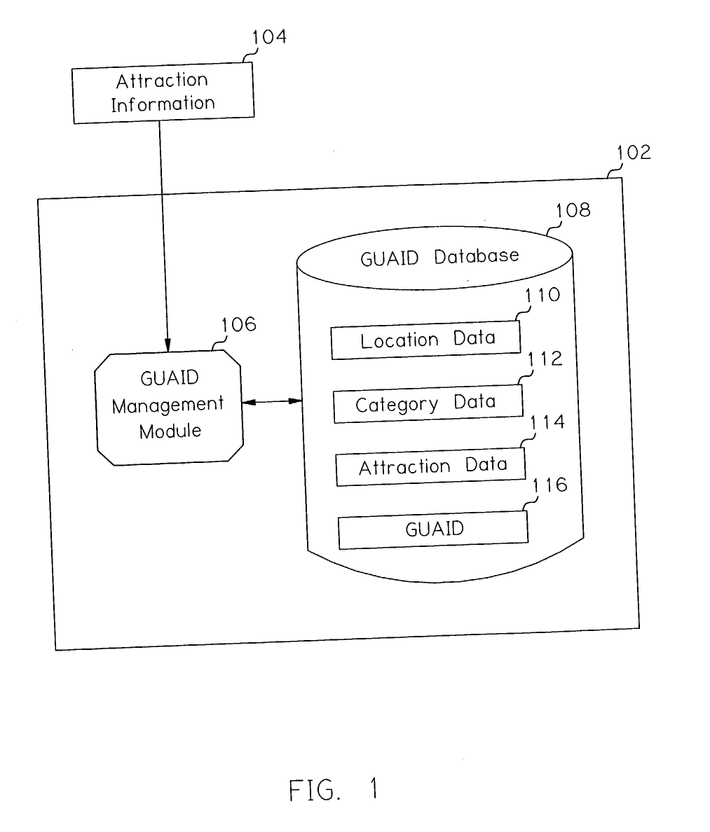

In the drawings, FIG. 1 is an overall block diagram of the GUAID management system typical of the present invention.

In this system, the GUAID management system 102 contains GUAID Management Module 106 and GUAID Database 108.

The GUAID Database 108 contains Location Data 110, Category Data 112, Attraction Data 114, and/or GUAID 116.

The GUAID Management Module 106 receives Attraction Information 104, accesses GUAID Database 108 and generates GUAID for the attraction if it is unregistered. If the system administrator modifies the generated GUAID, the GUAID Management Module 106 receives the modified GUAID and saves both the GUAID and the attraction information.

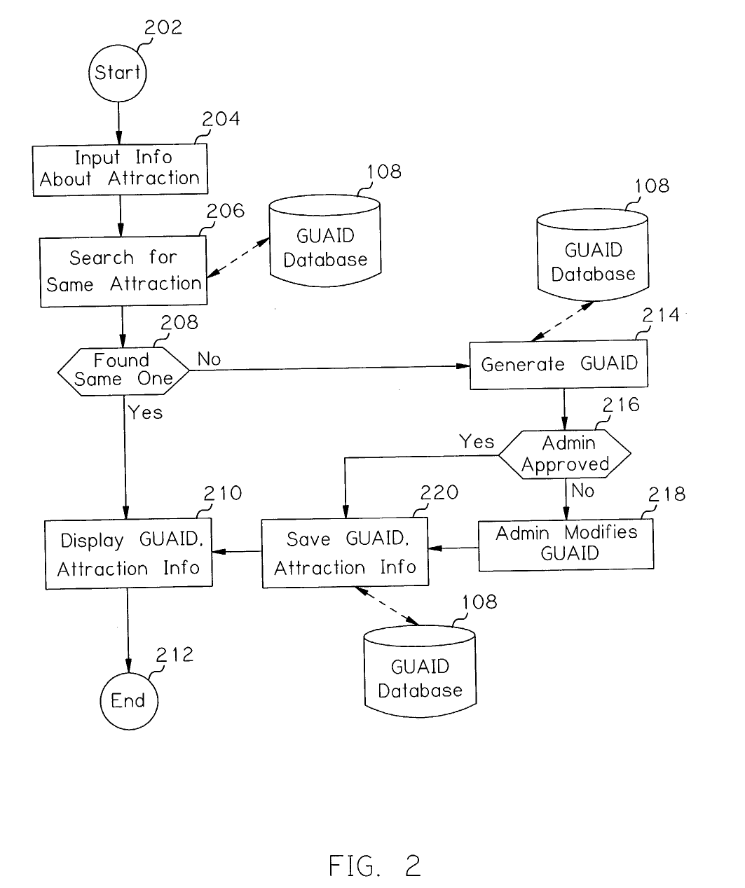

FIG. 2 is a flow chart illustrating the operations of the GUAID Management Module shown in FIG. 1.

Processing begins at Start block 202.

The system receives information about the attraction in block 204 and searches the GUAID Database 108 in block 206.

Decision block 208 determines whether the system found that particular attraction. If the system did, the program displays the GUAID and the attraction information, and processing stops at block 212.

When the system did not find that particular attraction at decision block 208, processing proceeds to block 214, where the system accesses GUAID Database 108 and generates a new GUAID.

Decision block 216 receives confirmation for the generated GUAID from the system administrator. If the administrator does not approve the generated GUAID, the administrator can modify the GUAID. The system receives the modified GUAID from the administrator at block 218 and goes to block 220. If the administrator did approve the GUAID generated by the system, the processing goes to block 220, where the new GUAID and the inputted attraction information are saved into the GUAID Database 108.

Processing goes to block 210, where the system displays the GUAID and the attraction information, and processing stops at block 212.

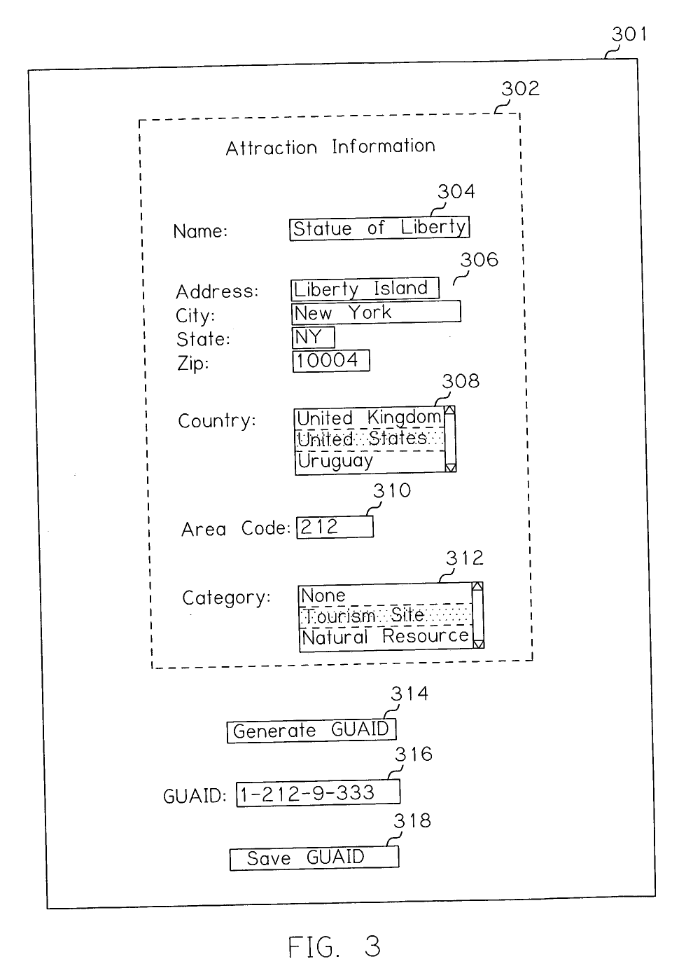

FIG. 3 is a typical display screen that shows the GUAID assignment interface.

The typical display screen is shown in block 301.

The Attraction Information 302 contains the following information: its Name 304, its Address 306, the Country where it is located 308, the relevant Area Code 310, and/or its Category 312.

After all available attraction information is inputted, the administrator may press “Generate GUAID” 314 to generate the GUAID automatically.

The generated GUAID will be displayed in GUAID edit box 316.

In the example shown in FIG. 3, the first character “1” stands for the country “United States”; string “212” stands for the area code; character “9” stands for the category “Tourism Site”; and string “333” is the sub-string for the attraction according to its location and category.

If the administrator is not satisfied with the generated GUAID, the administrator will modify it in GUAID edit box 316.

When the administrator is satisfied with the generated or modified GUAID, the administrator will press “Save GUAID” 318 to save the GUAID and Attraction Information 302 into the GUAID Database 108.

Advantages

From the description above, a number of advantages of the present invention become evident:

(a) It assigns globally unique identifiers for attractions easily and automatically.

(b) The identifier, GUAID, also contains information about the location and category of the attraction.

(c) It provides the possibility of identifying and accessing information about attractions by means of their unique identifiers.

Conclusion and Scope

Accordingly, readers can see that the present invention can be used to assign globally unique identifiers that identify attractions based upon their geographical locations and/or categories. When the information about the attraction is stored, the unique identifier can be used as a bookmark to retrieve relevant information.

Although the present invention has been described in detail, it will be understood that this description is not intended to limit the invention to this embodiment. Instead, it is intended to cover all alternatives, modifications and equivalents as may be included within the spirit and scope of the present invention as defined by the appended claims.

I claim:

1. For use with a computer, a GUAID management system for assigning globally unique identifiers to attractions based upon attributes of the attractions, comprising:
a database storing GUAIDs and attraction information; and
means for receiving unregistered attraction information and assigning a GUAID for the attraction based upon the information about the attraction.

2. The GUAID management system as recited in claim 1 wherein said attributes of the attractions selected from the group consisting of:
geographical locations,
categories.

3. The GUAID management system as recited in claim 1 wherein said database storing GUAIDs and attraction information contains data selected from the group consisting of:
geographical location data,
category data,
attraction data,
GUAIDs.

4. The GUAID management system as recited in claim 1 wherein said means for receiving unregistered attraction information and assigning a GUAID for the attraction based upon the information about the attraction comprising:
means for storing GUAIDs and attraction information in a database;
means for verifying that the inputted attraction is unregistered based upon the attraction information;
means for generating a GUAID for the unregistered attraction;
means for receiving a modified GUAID for the unregistered attraction from the administrator;
means for saving the GUAID and attraction information for the attraction.

5. A computer-implemented GUAID management method for assigning globally unique identifiers to attractions based upon attributes of the attractions, comprising the steps of:
storing GUAIDs and attraction information in a database; and
receiving unregistered attraction information and assigning a GUAID for the attraction based upon the information about the attraction.

6. The GUAID management method as recited in claim 5 wherein said attributes of the attractions selected from the group consisting of:
geographical locations,
categories.

7. The GUAID management method as recited in claim 5 wherein said storing GUAIDs and attraction information contains data selected from the group consisting of:
geographical location data,
category data,
attraction data,
GUAIDs.

8. The GUAID management method as recited in claim 5 wherein said receiving unregistered attraction information and assigning a GUAID for the attraction based upon the information about the attraction comprising the steps of:
storing GUAIDs and attraction information in a database;
verifying that the inputted attraction is unregistered based upon the attraction information;
generating a GUAID for the unregistered attraction;
receiving a modified GUAID for the unregistered attraction from the administrator;
saving the GUAID and attraction information for the attraction.
